(19) United States
(12) Patent Application Publication
(10) Pub. No.: US 2002/0090491 A1
(43) Pub. Date: Jul. 11, 2002

(54) Transforming polygons with pyramids

(76) Inventor: Daniel Richard Fox, Westerly, RI (US)

Correspondence Address: Daniel R. Fox, 49 Noyes Neck Rd., Westerly, RI, 02891, US

(21) Appl. No.: 09/756,635

(22) Filed: Jan. 8, 2001

(51) Int. Cl. B32B 3/12

(52) U.S. Cl. 428/116

(57) ABSTRACT

A geometric progression unfolds itself and reveals powerful relationships with several different complex areas of geometry. It all begins with two extremely flexible enlargement procedures of two simple shapes, the two procedures succeed in enlarging themselves utilizing only themselves. This opens the Nay for a repetitive honeycombing network, one flexible enough to adapt to and embody all of our concentrical polygons. These precise interfaces with the polygons actually creates a true geometric matrix, which transforms each of the polygons into a unique 3-dimensional structurally honeycombed cylinder, all capable of the same tantalizing design controls. Engineers in the near future will have a substantial array of options and the versatility to manipulate each of them; thereby providing the means to meet any challenge.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

REFERENCE TO A MICROFICHE APPENDIX

“Not Applicable”

### BACKGROUND OF THE INVENTION

My procedures utilize known shapes from various geometric categories including polygons and pyrailida, however several unexplored geometric matrixes are developed here which unveil compelling breakthroughs, in solid geometry and the inherent beneficial functions therein. The procedures and the matrixes are also completely unrelated to Buckminster Fuller and the Geodesic dome, which I find completely piecemeal and lacking a natural geometric progression.

### BRIEF SUMMARY OF THE INVENTION

As everyone knows our basic polygons the triangle, square, pentagon, hexagon, heptagon, octagon, and all the rest can be divided concentrically into slices each according to the polygons number of sides. My procedure will then subject, any and all of these slices to the same universal three dimensional honeycombing process, which in effect will transform each polygon into an elevated, structurally honeycombed cylinder that is capable of expanding itself outward and upward, with more honeycombing to any size imaginable.

This report will demonstrate the fundamentals of the structural networks and the vast, intriguing design capabilities therein. It will illustrate how the outward appearance of all the cylinders can be sculpted and shaped to accomodate a multitude of purposes. This report will also explain how honeycombing units and whole areas of honeycombing units can be altered in size to meet structural and design needs, and as with the outside, any unnecessary honeycombing on the inside can be sculpted away during the design stages leaving many possible structural configurations. All of these methods and functions can be employed on a very large scale, or in a miniature environment.

### BRIEF DESCRIPTION OF THE SEVERAL VIEWS OF THE DRAWINGS

FIGS. 1.1 and 1.2 show how a pentagonal cylinder can be designed tall and thin or short and wide.

FIG. 1.3,illustrates how a pentagonal cylinder is comprised by the stacking of two separate configurations.

The figures at the top of page two depict the two simple shapes as found in the pentagonal cylinder.

The left side of page two illustrates the very important enlargement process of one of the two simple shapes.

The right side of page two illustrates how that process can grow much taller.

FIGS. 3.1, 3.2, 3.3, 3.4, 3.5., 3.6, and 3.7 illustrate a different enlargement process—one that succeeds in the enlargement of the square based pyramid. These enlargement processes are absolutely essential for the honeycombing of any cylinder.

FIGS. 4.1 and 4.2 illustrate the concentrical joining of one of the two simple shapes.

FIGS. 4.3 and 4.4 illustrate the concentrical joining of the other simple shape.

FIG. 5.1 illustrates how, after the important stacking process of FIG. 1.3, the extremely large pentagonal cylinder can be sculpted down on the outer honeycombing to create a skyscraper. The inside would also lose most of it's honeycombing leaving behind a fascinating structural system.

FIG. 6.1 depicts a shorter, wider pentagonal cylinder designed for a much different purpose than FIG. 5.1. This application could cover a great distance utilizing the patterns ability to interlock while leaning in on each other.

FIG. 7.1 is a top view of FIG. 6.1 and it shows how the five main trusses emanating from the center are of a smaller honeycombing making them very strong. The areas in between have more open honeycombing to help span the gaps, the shaded areas depict reinforced cement.

FIG. 8.1 is a side view of one of the five main trusses in FIG. 6.1 and it shows how easily these extractions can be designed for more strength.

FIG. 9.1 again shows some of the immense design control inherent to the honeycombing system.

FIG. 10.1 depicts the enlargement processes of both simple shapes for a wider type wedge possibly of the four sided polygon (the square) or the pentagon.

FIG. 10.2 depicts the enlargement processes of a narrower wedge than of FIG. 10.1, possibly the hexagon or the heptagon.

FIG. 10.3 depicts an even narrower wedge being honeycombed which helps illustrate the ability to honeycomb any wedge imaginable with the two enlargement processes.

FIG. 11.1 illustrates the mathematical constant that all of the cylinders are elevated by the matrix to a height exactly half the length of any side of the related polygon.

FIG. 11.2 illustrates the height given by the matrix to the octagon.

FIG. 11.3 depicts a fully cylinderized pentagon.

FIG. 11.4 depicts a fully cylinderized octagon.

FIG. 11.5 depicts a full wedge of a pentagonal cylinder and how the honeycombing can be utilized in only part of that full wedge.

FIG. 11.6 depicts a full wedge of an octagonal cylinder and how the honeycombing can be utilized in only a part of that full wedge also.

FIG. 12.1 depicts the honeycombing versatility of a wedge from the hexagonal cylinder.

FIG. 12.2 depicts a hexagonal structure utilizing many of the assets of the honeycombing system created when the matrix elevates and gives structure to the hexagon.

FIG. 12.3 depicts a top view of FIG. 12.2 and illustrates the uniformity of the honeycombing and also the versatility.

FIG. 13.1 depicts the honeycombing versatility of a wedge from the octagonal cylinder.

FIG. 13.2 depicts an octagonal structure utilizing many of the assets of the honeycombing system created when the matrix elevates and gives structure to the octagon.

FIG. 13.3 depicts a top view of FIG. 13.2 and illustrates the uniformity of the honeycombing and also the versatility.

FIG. 14.1 depicts the honeycombing versatility of a wedge from the decagonal cylinder.

FIG. 14.2 depicts a decagonal structure utilizing many of the assets of the honeycombing system created when the matrix elevates and gives structure to the decagon.

FIG. 14.3 depicts a top view of FIG. 14.2 and illustrates the uniformity of the honeycombing and also the versatility.

### DETAILED DESCRIPTION OF THE INVENTION

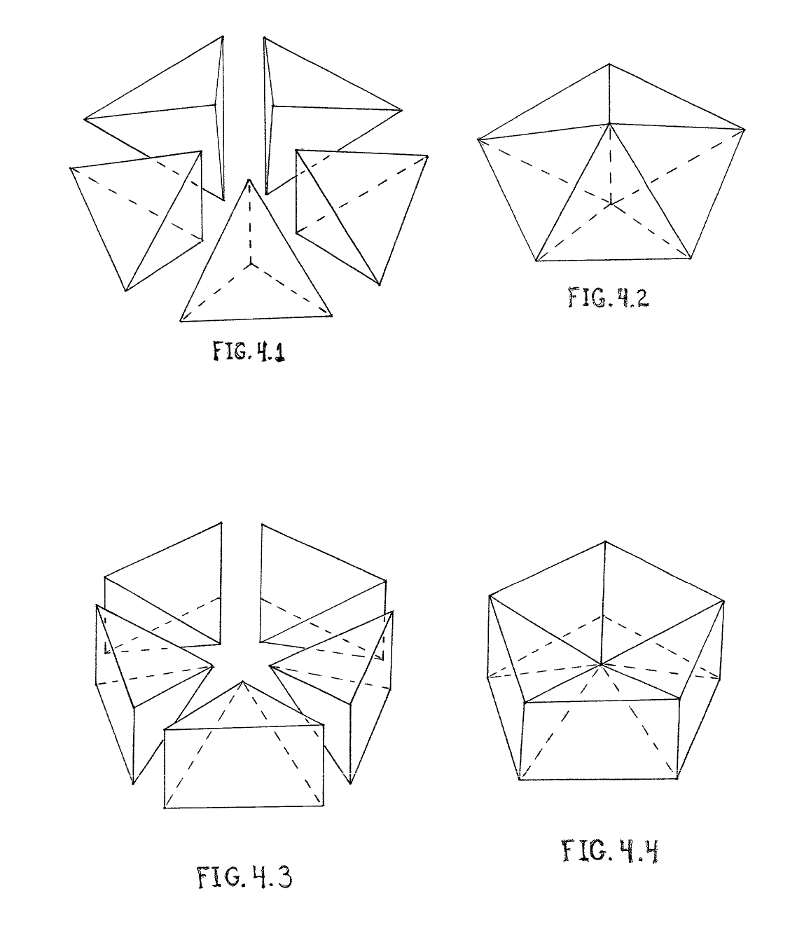

All of the basic polygons can be divided concentrically into slices or wedges, each according to the given polygons number of sides. Mathematically all of the slices from the same polygon will be equal to each other, or similiar to each other. The slices from completely different polygons can narrow or widen signifigantly, however, logically every single one of these polygonal slices will have exactly one specific square based pyramid that aligns perfectly with that slice when that pyramid is viewed from the side. (see FIG. 4.3 for the pentagon alignment).

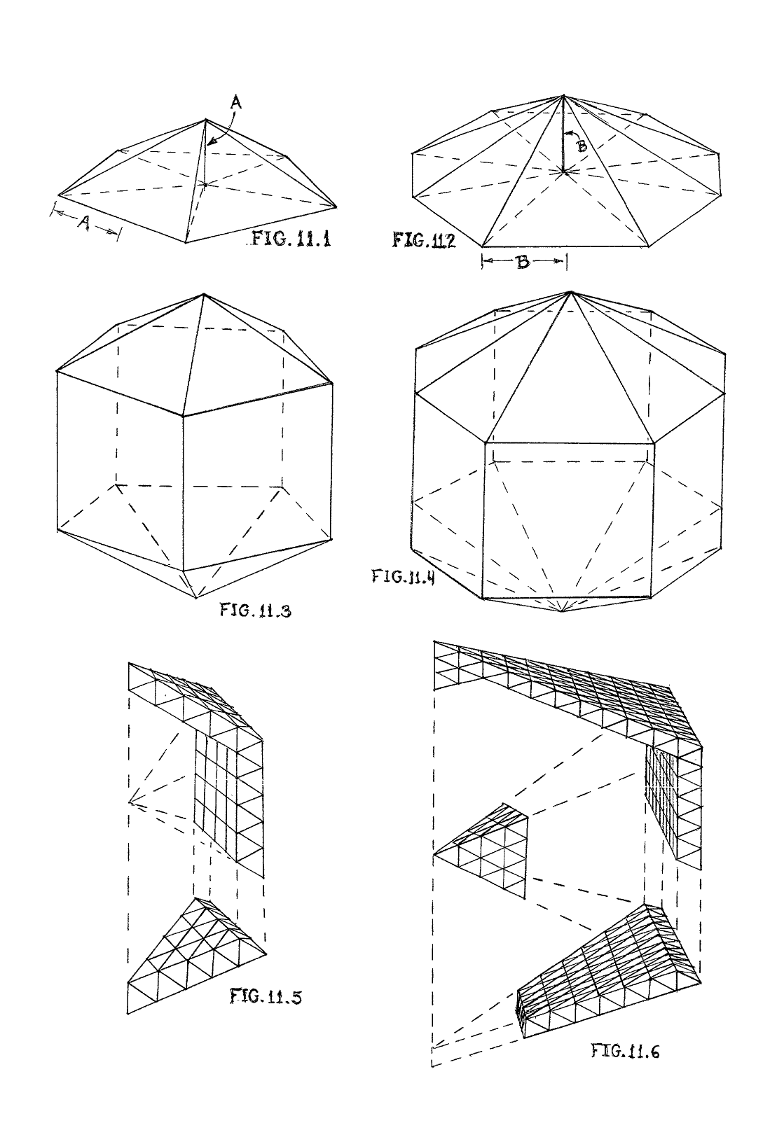

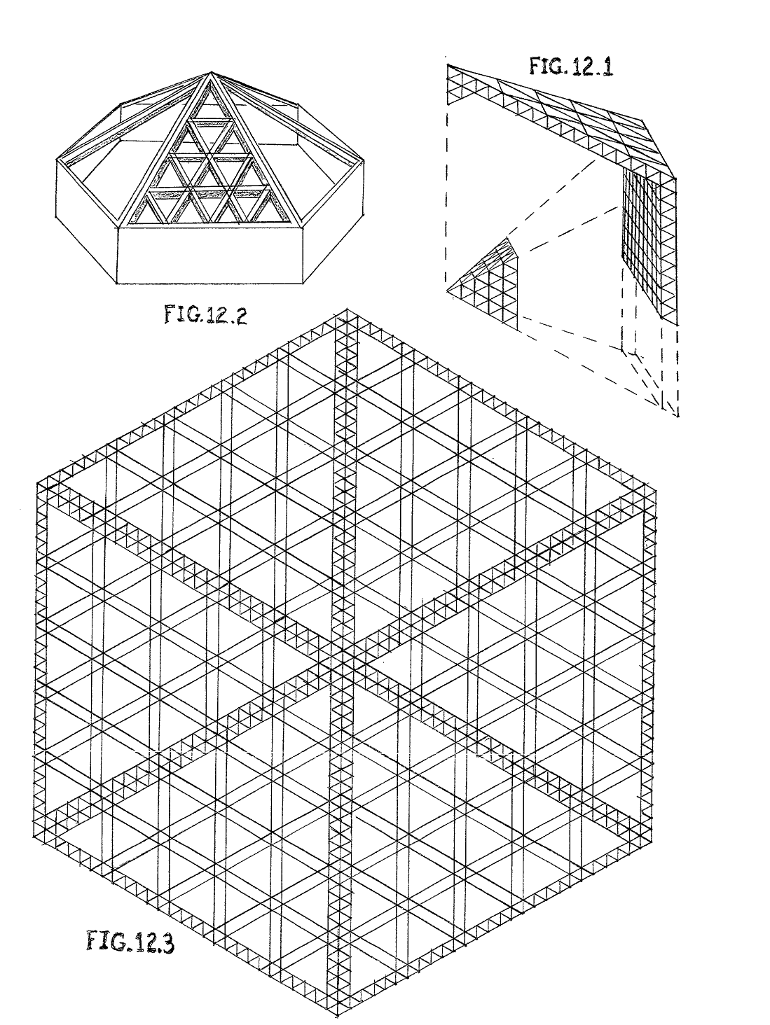

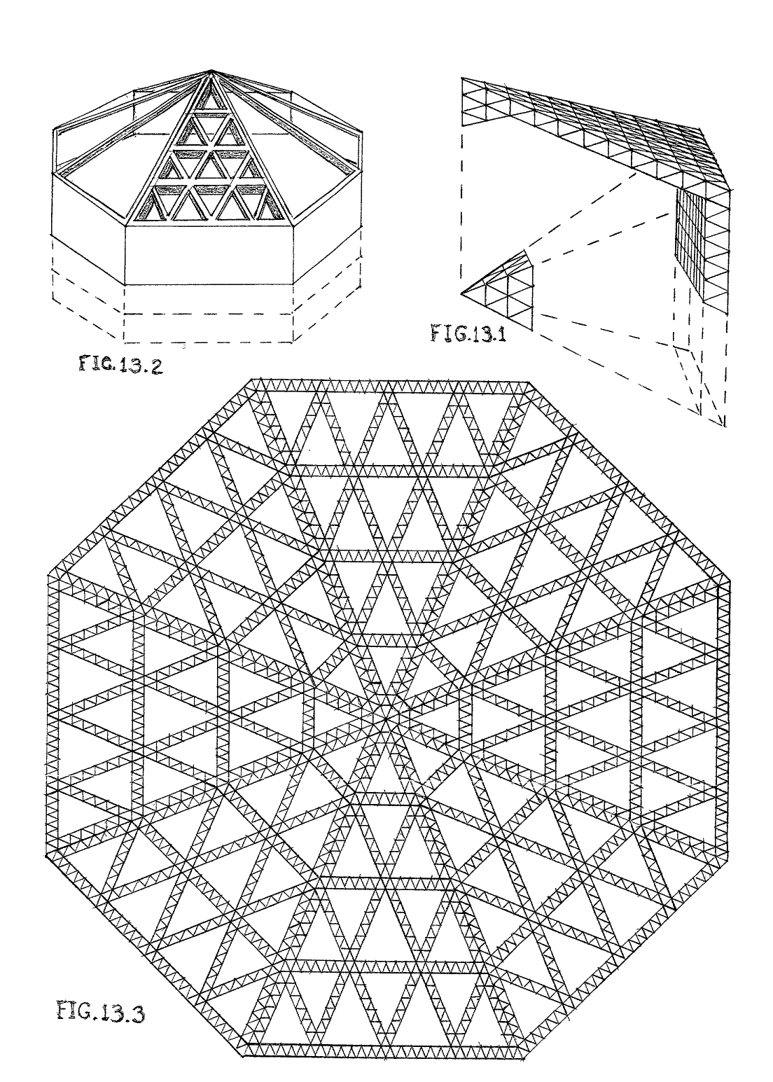

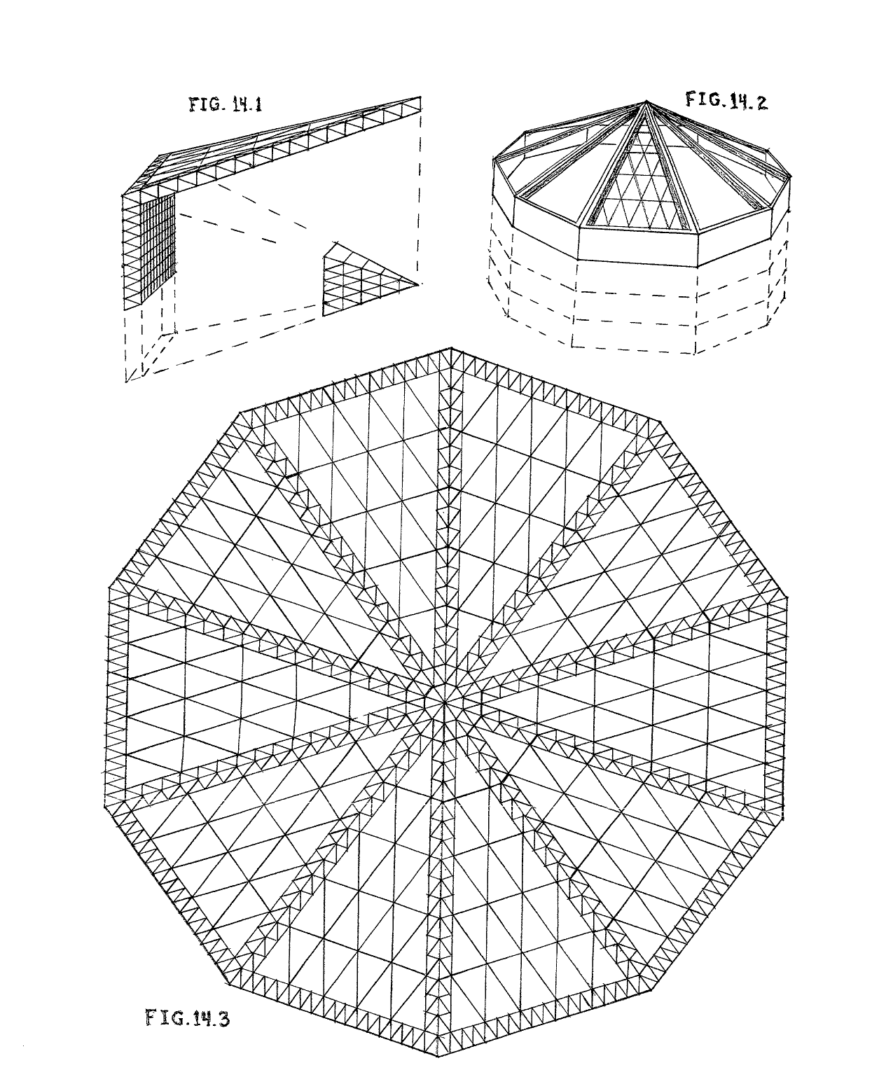

My procedure will then subject any and all of these square based pyramids to a flexible honeycombing process, thus allowing a geometric matrix to occur, whereby, any of the simple polygons can be transformed into elevated, structurally honeycombed cylinders. (see pages 10,11,12,13, and 14 of the drawings.). The relatively few polygons that can receive this honeycombing system can all progress into it's own unique cylinder shape. (see pages 10 through 14 of the drawings, again for some examples). An important part of each cylinders uniqueness is the height of the apex on each end of the cylinder. (see FIGS. 11.1 and 11.2 for an illustration of the pentagon and the octagon.). Mathematically this height is exactly half the length of any side of the given polygon.

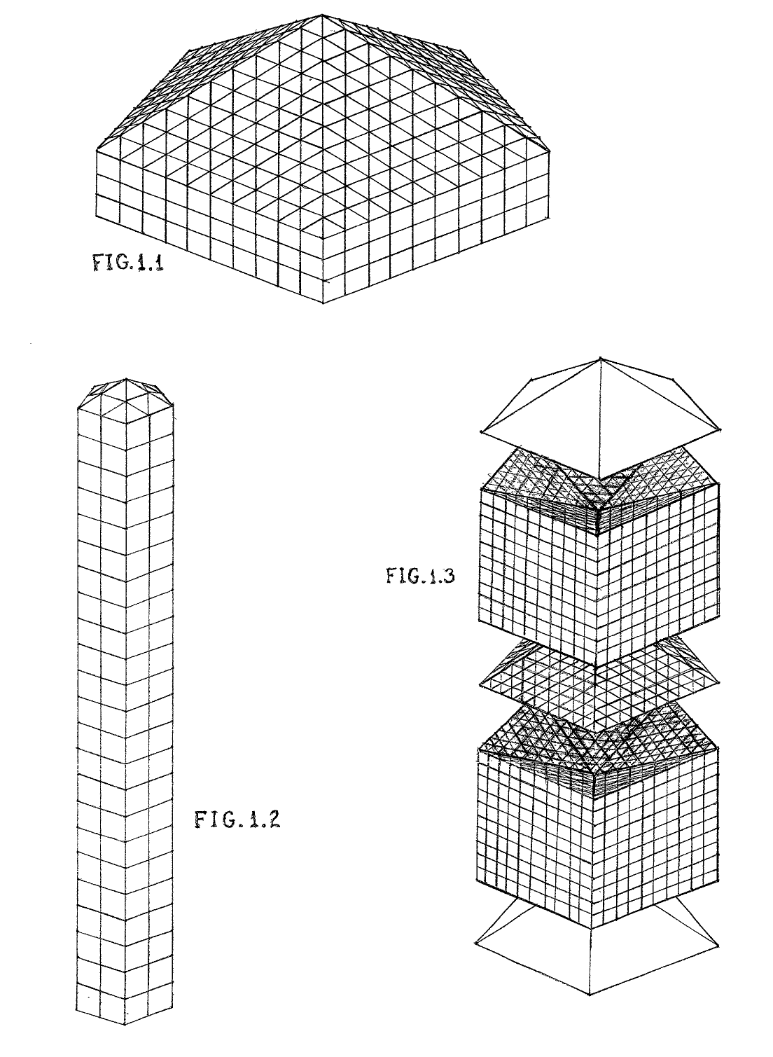

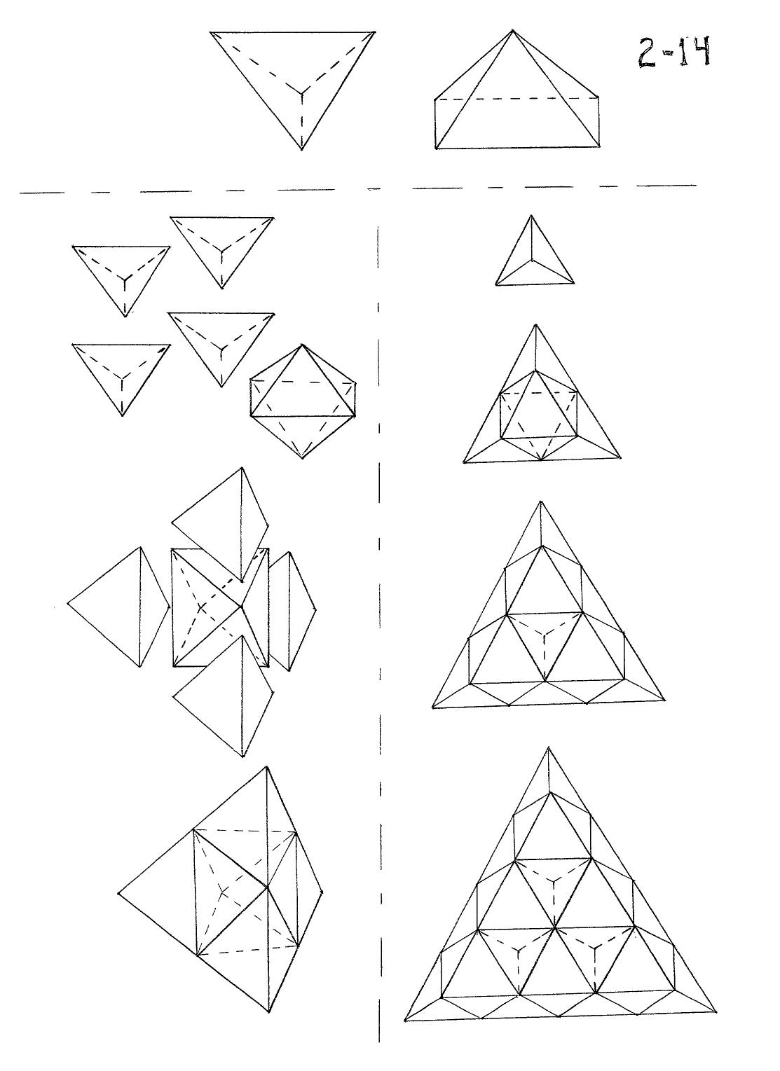

Any of the cylinders can be made tall and thin or short and wide. (see FIGS. 1.1 and 1.2 for the pentagon example.). Each cylinder is made up entirely of two simple shapes which integrate with each other or by themselves in specific, rigid methods. The shapes intermingle and compliment each other by joining together on several levels. I will continue this specification with the illustration of the pentagonal cylinder. The two simple shapes within the pentagonal cylinder are depicted at the top of page two of the drawings. The first step in the procedure is slightly more complex than the others, it is intriguing in it's configuration and it is indispensable for the honeycombing itself. (see the left side of page two of the drawings.). These drawings illustrate how two square based pyramid shapes are put back to back and laid down on one side, it is then joined by four units of the triangular based pyramid and this accomplishes the enlargement of the triangular based pyramid. The next sequence (see the right side of page) is of four top views depicting the process of adding more units in layers and thus creating an even larger triangular based pyramid.

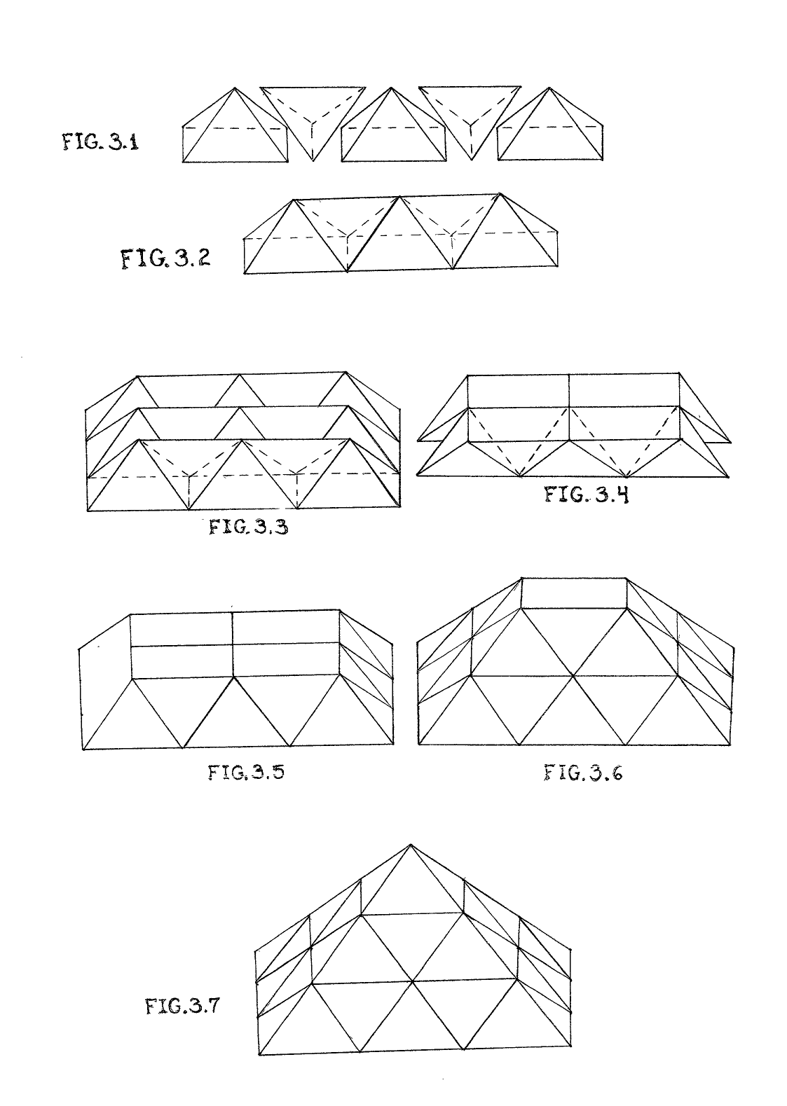

The enlargement of the square based pyramid is next, this process is easier to visualize than the last. First we take several of each of the two simple shapes and line then up (see FIGS. 3.1 and 3.2) next we make a solid layer using several of these strips, some of the strips being used upside dowel. (see FIGS. 3.3 and 3.4). To finish the enlargement of this pyramid we simply put Lore of these solid layers upon others (see FIGS. 3.5 and 3.6) and then top it off with one square based pyramid. (see FIG. 3.7)

Now that we can extensively honeycomb both of the basic shapes with the two enlargement processes we can move on to the third step. Here, we take five of those extensively honeycombed triangular based pyramids (see FIGS. 4.1 and 4.2) and join them concentrically into a five sided configuration which will completely align and interlock all of the exposed honeycombing on each of the joined surfaces.

The fourth step is much like the third step except that we take five of the extensively honeycombed square based pyramids (see FIGS. 4.3 and 4.4) and join them concentrically into a five sided configuration, like step three, all of the honeycombing on each joined face will align perfectly and could fasten together for strength.

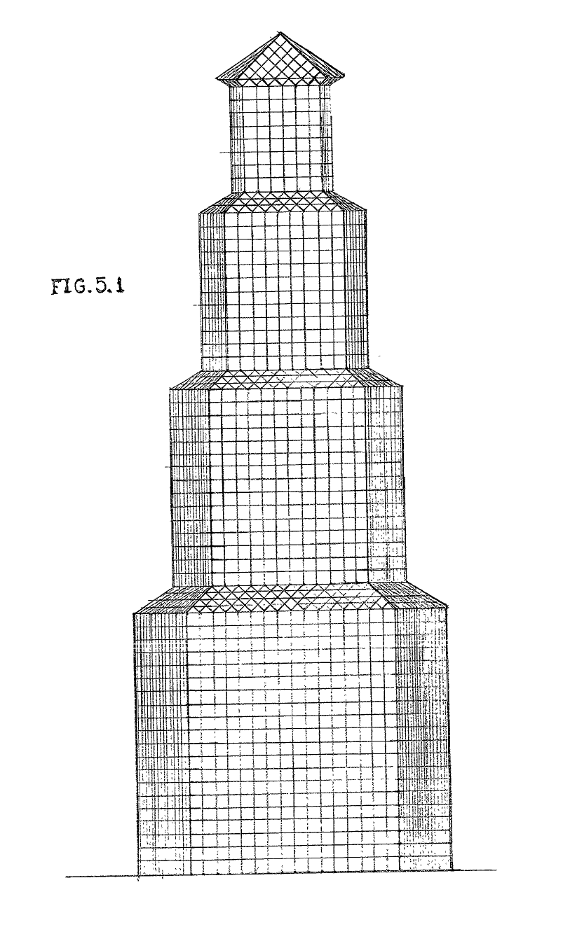

The fifth step finally reveals how each cylinder is structured (see FIG. 1.3) this drawing illustrates how an engineer would stack as many of the five sided configurations as a structure may require, and as before, all of the honeycombing that comes in contact with other honeycombing will align perfectly and could fasten together far enormous strength. At this point, we have a solid honeycombing network or pattern within a unique geometric cylinder; and as we will see an extremely large cylinder can be established and then be outwardly sculpted to become a massive skyscraper. (see FIG. 5.1). The sculpting would continue on the inside utilizing the patterns unique configuration to obtain an advanced, economical structural system of unprecedented strength.

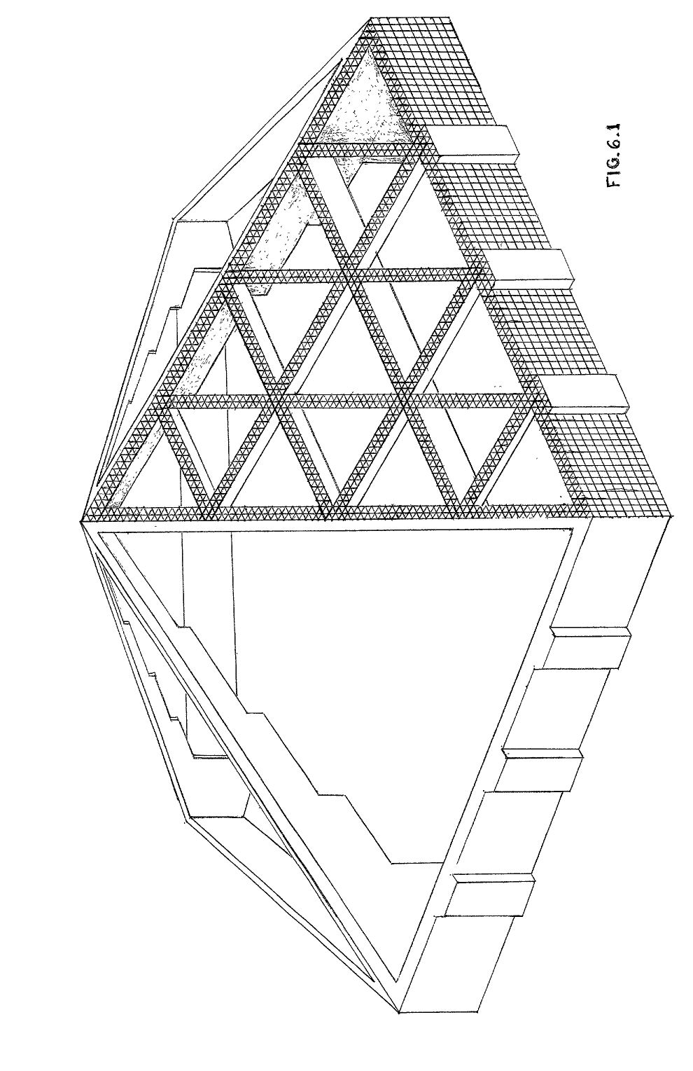

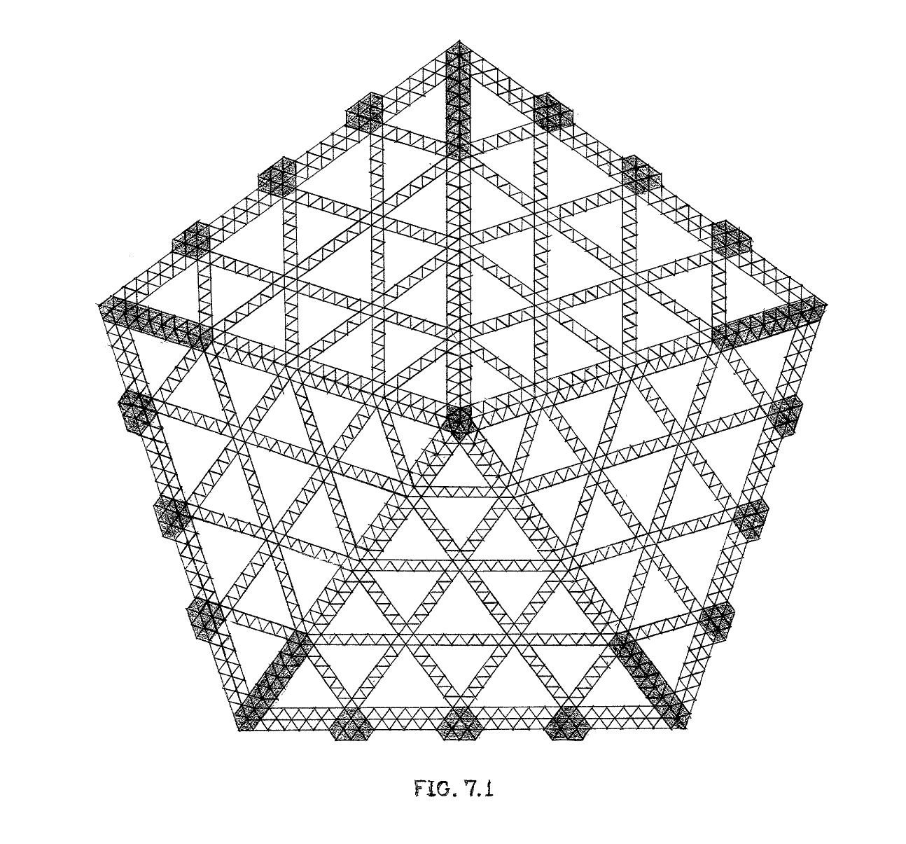

The honeycombing pattern has an enormous amount of inherently rigid guidelines and steps that must be followed to establish the repetitive honeycombing network; However, to point out the patterns flexibile nature we must examine how the honeycombing allows for the ability to manipulate different parts of itself for specific purposes. First, by being able to vary the sizes of the honeycombing units anywhere within a cylinder, an engineer can utilize smaller honeycombing units with several layers to create massive load bearing trusses. (see FIG. 6.1). Larger more open honeycombing will be lighter and capable of spanning large openings between the structural members, (see FIG. 7.1) amazingly, even these different parts of the structure can align and support each other.

Perhaps the greatest flexibility of the pattern is the ability to elongate the two simple shapes to various lengths without losing any of the previously mentioned characteristics. (see—page 10 of the dwgs.). The solidily honeycombed wedge of a pentagonal cylinder (see left side of page eleven of the dwgs.) would become a slightly narrower, solidily honeycombed wedge (see right side of page 11.) that of the octagonal cylinder. The flexible nature of the matrix thereby allows all of our basic concentrical polygons to be transformed into elevated, uniformily structured cylinders all with the same signifigant, inherent design controls. (see pages 6,12,13, and 14 of the drawings for several examples).

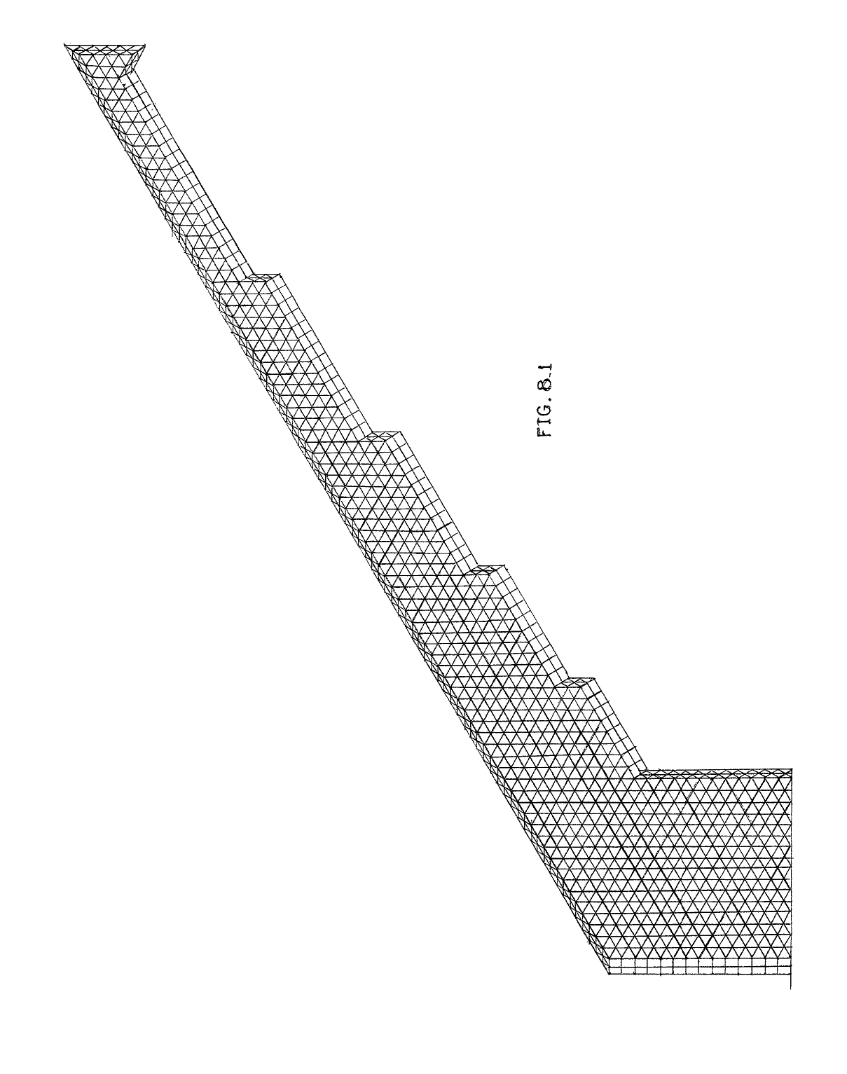

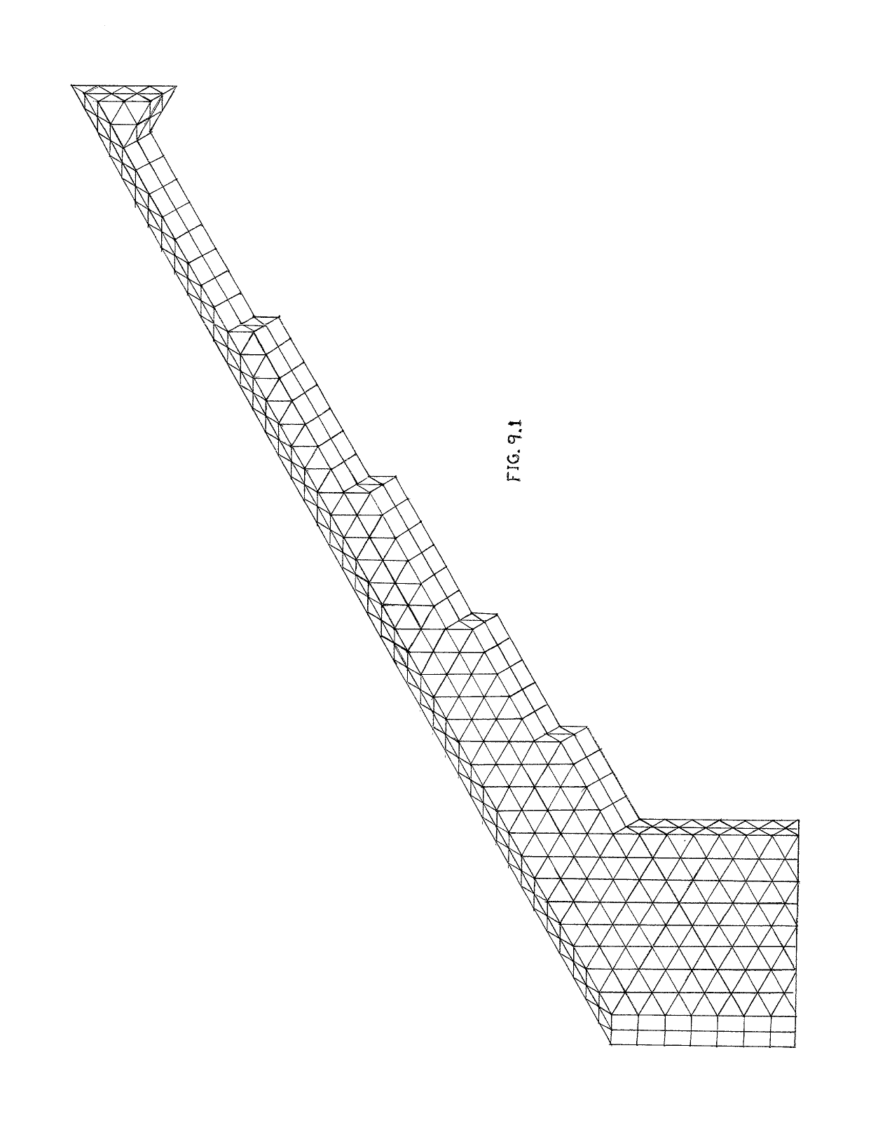

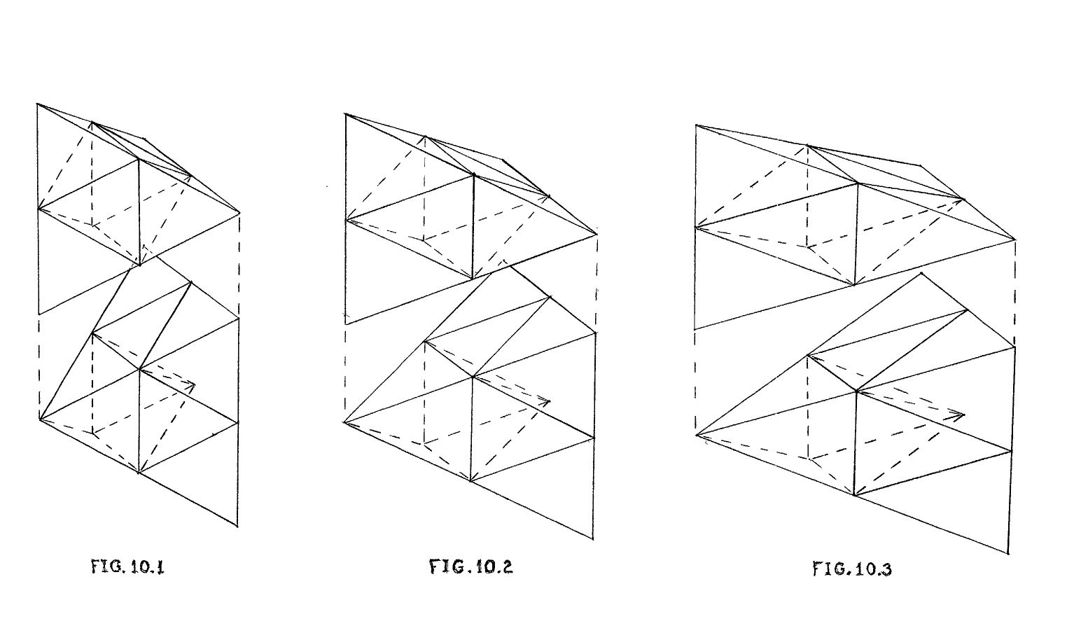

Finally, all of the cylinders may look simple and unassuming on the outside, but, when certain sections are scrutinized like the main truss from FIG. 6.1 it can become difficult to easily understand all of the exposed angles and surfaces. (see FIG. 8.1) FIG. 9.1 shows that same truss, only with larger units of honeycombing which helps illustrate some of that design control.

1. I claim the two enlargement processes of the two simple shapes when they have been elongated or shortened to any length.

2. I claim the unique cylinderized shapes and the versatile honeycombing patterns, or any section or sections of these honeycombing patterns within these cylinders, which are created when the processes of the first claim properly align and interface with the following polygons, the triangle, square, pentagon, hexagon, heptagon, octagon, and also the 9, 10, 11, 12, 13, 14, 15, 16, 17, 18, 19, and 20 sided concentrical polygons.

3. I claim the cylinderized shapes and the honeycombing patterns of the second claim when constructed with the honeycombing units at any size imaginable and the ability to extend the honeycombing upward and outward without limit.

4. I claim the ability of the patterns from the second claim to contain an area or areas with altered size pieces of honeycombing.

5. I claim the patterns and cylinderized shapes from the second claim when comprised of any material known to mankind.

6. I claim the patterns and cylinderized shapes from the second claim when joined by any method known to mankind now or in the future.

7. I claim any production that utilizes the cylinderized shapes or the patterns thereof, from the second claim.
